(19) United States
(12) Patent Application Publication
(10) Pub. No.: US 2014/0315412 A1
(43) Pub. Date: Oct. 23, 2014

(54) Electric Cable Plug Connecting Device and Method

(71) Applicant: Charles Tripp, El Cerrito, CA (US)

(72) Inventor: Charles Tripp, El Cerrito, CA (US)

(21) Appl. No.: 13/963,946

(22) Filed: Aug. 9, 2013

Related U.S. Application Data
(60) Provisional application No. 61/682,086, filed on Aug. 10, 2012.

(51) Int. Cl. H01R 13/639; H01R 43/26

(52) U.S. Cl. CPC H01R 13/639; H01R 43/26
USPC 439/349; 29/876

(57) ABSTRACT

A plug adaptor device and method for using the same, the device including anchor and clip components for attachment with electric cable plugs and/or wall (or floor) sockets or socket faceplates. Corresponding anchor and clip components are separately attachable to electric cable plugs or sockets and used to secure plug to plug or plug to socket connections. The components are engaged by sliding the toe portion of the clip over the anchor so that a claw protrusion fits snugly behind the inside edge of the anchor thus preventing the connected plugs (or plug and socket) from being accidentally disconnected. When engaged, the plug adaptor device provides enough resistance to an opposing pulling force to prevent accidental disconnections allowing disconnection with application of a reasonable amount of pulling force in emergency situations.

### CROSS-REFERENCE TO RELATED APPLICATIONS

This application claims the benefit of provisional patent application Ser. No. 61/682,086, filed 2012 Aug. 10 by the present inventor.

### BACKGROUND

1. Field of Invention

The present invention is in the field of tools used for industrial, commercial and home use, specifically a device and method for safely securing connected plug ends of electric cables and/or a plug end of an electric cable to a socket or socket faceplate.

2. Prior Art

The following is a tabulation of some prior art that presently appears relevant:

| U.S. Pat. No. | Issue Date | Patentee |
|---|---|---|
| 4,440,465 | Apr. 3, 1984 | Elliott |
| 4,514,026 | Apr. 30, 1985 | Herbert |
| 4,832,618 | May 23, 1989 | Gunderson |
| 4,898,542 | Feb. 6, 1990 | Jones, Jr. |
| 4,917,626 | Apr. 17, 1990 | Barton |
| 4,957,450 | Sep. 18, 1990 | Pioszak |
| 5,044,976 | Sep. 3, 1991 | Thompson |
| 5,104,335 | Apr. 14, 1992 | Conley et al. |
| 5,167,524 | Dec. 1, 1992 | Falcon et al. |
| 5,179,044 | Jan. 12, 1993 | Muromachi et al. |
| 5,316,493 | May 31, 1994 | Sowers |
| 5,336,106 | Aug. 9, 1994 | Osten |
| 5,348,495 | Sep. 20, 1994 | Kasden |
| 5,573,420 | Nov. 12, 1996 | Grosswendt |
| 5,591,043 | Jan. 7, 1997 | Kenney |
| 5,752,848 | May 19, 1998 | Youngmark |
| 5,755,588 | May 26, 1998 | Sweatman et al. |
| 6,033,251 | Mar. 7, 2000 | Cook |
| 6,071,142 | Jun. 6, 2000 | Blackman |
| 6,979,221 | Dec. 27, 2005 | Hunter |
| 7,052,303 | May 30, 2006 | Burton |
| 7,081,004 | Jul. 25, 2006 | Puzio |
| 7,470,141 | Dec. 30, 2008 | Yoest |
| 7,887,360 | Feb. 15, 2011 | Andrade |

Persons relying on electrically powered tools and systems often must utilize a variety of electrical cords, plugs, sockets and connectors to complete work and other tasks. These tools and systems often require the safe and efficient use of electrical tools, electrical power cables, wall sockets and other electrical connection devices which may accidentally unplug themselves or disconnect in the course of normal use creating inconvenience and safety hazards.

Persons involved in the construction trades or who perform maintenance and other work requiring the use of electrical cables are acutely aware of the problems associated with making sure that electrical cables, whether connected together (plug to plug) or connected with a wall socket (plug to socket), do not come disconnected accidentally. For example, it is not uncommon for construction personnel to connect electrical cables together or an electrical cable to a wall socket, climb on a ladder or scaffolding with an electrical power tool or lighting accessory in hand, and have the electrical cable become accidentally unplugged to another cable or to a wall socket. When this happens, the person must get down off the ladder or scaffolding, check each connection and reconnect the plugs before getting back to work. The lack of connection can result from any number of factors including but not limited to someone moving the cable and disengaging the plugs just enough to cause a disconnection at a plug to plug and/or plug to socket juncture. Another factor could be associated with wear on the electric cable plug components. It is not uncommon, for example, for the prongs of the male plug types to become worn, bent or otherwise loose from the plug housing which contributes to the prongs not seating properly to a female plug or socket. Similarly, it is not uncommon for the holes in a female plug type or socket to become worn and enlarged during use and thus not hold the male prongs securely. Thus, electrical cable plugs and sockets can lose their useful life over time and use not because they don't conduct electricity well, but because they no longer connect well.

For these reasons and others, prior art devices and methods have been developed for preventing electrical cable plugs from disconnecting from one another or from a socket. A review of the prior art reveals that these prior art devices and methods are either ineffective, too difficult to use and/or create significant safety hazards.

In addition to the patented devices and methods described in the various patents listed above, there are a variety of common approaches to preventing disconnection. A common approach, for example, is to tie the engaged male/female plug connections together with tape, wire, or strap ties and the like. This method can help prevent the plugs from being disengaged accidentally, but it creates a serious safety hazard in that it does not allow quick and easy disengagement during times of emergency. There are numerous situations when it may become immediately necessary to disconnect an electric cable quickly from another cable or a wall socket to prevent or discontinue electric current from injuring a person or causing damage to machinery. Plugs that are essentially tied together by tape, wire, tie straps and the like are difficult and time consuming to disengage. Similarly, many of the sleeve type devices described in the cited patents are difficult and time consuming to engage and disengage. Some require significant prior experience and knowhow to easier disengage. A person who has no prior experience disengaging a sleeve device (for example, a bystander tasked with reacting to an emergency situation) will likely have great difficulty disengaging the device and connections safely and quickly.

Current code requirements suggest and/or mandate that electric cable plugs be capable of disengaging from one another and/or from a socket upon no more than a reasonable amount of pulling force (usually 25 pounds or less). This is to ensure that a person can disengage them quickly if they need to in an emergency. Many prior art devices designed to prevent accidental disconnection require more than a reasonable amount of pulling force to disengage the plugs from one another or from a wall socket.

What is needed is a device and method for preventing electrical cable plugs from being accidentally disengaged from one another or from a socket easily and quickly without being too costly to make, too difficult to use and without creating safety hazards.

### SUMMARY OF INVENTION

In accordance with the principles of the invention, the inventive plug adaptor device solves the problems of the prior art by securing the connection between electrical cable plugs or electrical plugs and sockets without being too difficult to use and without creating safety hazards. The inventive plug adaptor device consists of anchor and clip components for attachment with electric cable plugs and/or wall (or floor) sockets or socket faceplates. The anchor component of the adaptor device is attachable with a male type plug end. The clipping component of the adaptor device is attachable with a female type plug end, wall socket or wall socket faceplate. Once the corresponding adaptor components are attached to corresponding plugs or socket, the plugs can be joined together and secured. By sliding the toe portion of the clip over the anchor component so that the claw protrusion fits snugly behind the inside edge of the anchor thus preventing the connected plugs (or plug and socket) from being accidentally disconnected. By sliding a finger under the toe portion of the clip and pulling the toe upwards, the claw protrusion is release from the anchor and the plugs (or plug and socket) can be easily disconnected. When engaged, the plug adaptor device provides enough resistance to an opposing pulling force to prevent accidental disconnections but also allows the plugs to be disconnected with a reasonable amount of pulling force in emergency situations.

One advantage of this mechanism over the prior art is that the anchor and clip components may be attached directly (and permanently if desired) to plugs and wall (or other) sockets and do not require that they be reattached each time they are used. Another advantage is that the components can be engaged easily without having to wrap or otherwise tie the plugs together. Another advantage is that the user may easily disengage the components from one another with one hand (if necessary). Another advantage is that the mechanical aspects of the adaptor are simple and easily understood. The clip mechanism is easily recognized by persons not already experienced with the device. Another advantage is that the connection can be disengaged using enough force to satisfy current suggested safety and code requirements even if the attachment mechanism remains in place. The components are light and strong, easy to make, inexpensive to package and ship, and the overall ease of operation is greatly enhanced over prior art devices.

Any features or combinations of features described herein are included in accordance with the invention provided that the features including in any such combination are not mutually inconsistent as will be apparent from the context, this specification, and the knowledge of one of ordinary skill in the art. Additional advantages and aspects of the present invention are apparent in the following detailed description and claim.

### BRIEF DESCRIPTION OF THE DRAWINGS

In addition to the written description provided herein, the inventor has included the following drawings demonstrating the principles of the invention.

FIG. 1 is a top perspective view of an embodiment of the adaptor device including anchor and clip components.

FIG. 2 is a side view of an embodiment of the invention including anchor and clip components.

FIG. 3A is a bottom view of an embodiment of the clip component of the invention.

FIG. 3B is a top view of an embodiment of the clip component of the invention.

FIG. 3C is a side view of an embodiment of the clip component of the invention.

FIG. 4A is a side view of the clip component of the invention showing base with integrated tie strap locking mechanism, integrated tie strap, heal, toe, lip, protruding claw, and flex point.

FIG. 4B is an opposing side view of the clip component of the invention showing base with integrated tie strap locking mechanism, heal, toe, lip, protruding claw and flex point.

FIG. 5A is a top perspective view of the clip component of the invention showing the tie strap engaged with the tie strap locking mechanism.

FIG. 5B is a side view of the clipping component of the invention showing the tie strap portion engaged with the tie strap locking mechanism.

### DETAILED DESCRIPTION

The drawings are for the purpose of illustrating preferred and alternative embodiments of the adaptor device and method for using it to secure electrical cable plugs to one another or to a wall (or other) socket or socket faceplate and are not for the purpose of limiting the same. For descriptive purposes, the adaptor device is comprised of two basic components: 1) the anchor component and 2) the clip component. The anchor component includes an anchor and, in some embodiments, means for attaching the anchor to a plug including but not limited to a locking tie strap, adhesives or adhesive tapes and other means for attachment known in the art. The clip component includes a clip having a base, heal, and toe portions. A flex point is located between the base and toes portions. The toe includes an angled outwardly extending lip and angled generally downwardly extending claw protrusion.

One will note that the embodiment of the adaptor device shown in the drawings has a single anchor component attached with a male plug end and a single clip component (comprised of various elements as further described below) attached to a female plug end. In alternative embodiments, one or more anchor and clip components may be utilized.

It should also be noted that the drawings show an embodiment where the clip component is securely attached to the female plug and the anchor component is securely attached to a male plug. This is preferable in most circumstances because, as one will appreciate from the drawings, portions of the clip component extend beyond the end of the plug and would impede a male plug end from being inserted into a socket unless the socket is uniquely designed to accept the extending portions of the clip component. However, alternative embodiments of the invention may have the clip component attached to a male type plug end and the anchor components attached to the female plug end. Alternative embodiments may have the clip component attached to a female socket or socket faceplate.

In the embodiments shown and described, the anchor and clip components of the invention are attached with a standard electric cable plug end that is approximately 1 inch in diameter. Alternatively, the components could be attached to plug ends that are larger or smaller in diameter. Further, one or more elements of the anchor and/or clip components could be alternatively built into the plug. For example, a plug may be designed and fabricated to have an anchor component thus negating the need to install an anchor component post fabrication. Similarly, the clip component could be built into a plug, socket or socket faceplate for similar reasons.

The embodiment shown in the various drawings described below utilizes a single tie strap as an anchoring component. This approach provides a uniform anchoring surface around the circumference of the plug. In alternative embodiments, however, one or more anchors may be utilized at differing positions around the circumference of the plug end to correspond with one or more clips attached to the corresponding plug, socket or socket faceplate.

Alternative embodiments of the adaptor device might include two or more clips to ensure engagement strength. For example, an alternative embodiment could have a clip mounted on one side of a plug and another clip component mounted on the opposing side of the plug. The general purpose of utilizing a single clip component is to insure ease of use and reduce costs of fabrication. For example, one will appreciate that disengagement of the device having a single clip component can be easily performed with one hand. But in varying circumstances it may be appropriate and beneficial to include more than one clip component to maintain the strength of connection or to provide alternative points of connection with one or more anchors located on varying positions around the circumference of the corresponding plug end, socket or faceplate. Similarly, alternative embodiments could include more than one claw protrusion extending from the toe of the clip. Or there could be more than one toe and more than one claw protrusion. All reasonable variations of the various described elements of the two basic components are contemplated.

A preferred embodiment of the components of the adaptor device are made of a light strong material with a reasonable amount of durability and elasticity such as vinyl, pvc, hard rubber and similar materials known in the art. Alternative embodiments could utilize other materials, alone or in combination, which are generally known and used in the construction industry and generally associated with the fabrication of tie straps and connecting devices. For example, the means for attaching the clip component to a plug could include a variety of materials such as metal bands, hook and loop connector and the like. However, it is important that the components be securely fastened with enough strength and elasticity to allow the clip component to function with the anchor component to prevent accidental disconnection without posing safety hazards.

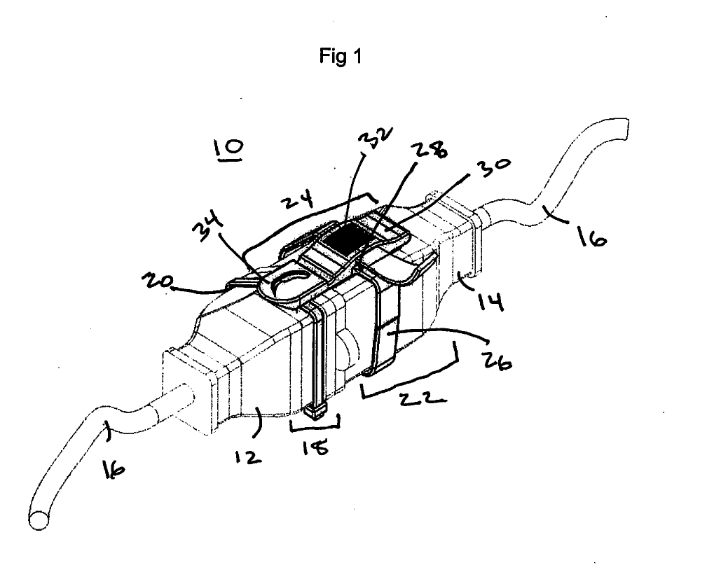

FIG. 1 is a top perspective view of the inventive adaptor device 10 securing the connection between corresponding male 12 and female 14 plugs of two electric cables 16.

As previously described, the adaptor device generally consists of two components; 1) an anchor component, and 2) a clip component. Each component is separately aligned and attached to corresponding plugs or socket/plug. When the corresponding plugs or plug/sockets are engaged, the clip and anchor components are engaged, thus preventing accidental disconnection. The purpose of the anchor component is to provide an anchor (or “snag”) to inhibit movement of plugs when the two components are engaged. The purpose of the clip component is to engage with the anchor when the plugs or plug/socket are joined, and disengage the anchor when the use wants to disconnect the plugs from one another or a plug from a socket.

The anchor component for the embodiment depicted in FIG. 1 is a standard locking tie strap which has been wrapped around and secured tightly with the circumference of the male plug 14. In a preferred embodiment, the standard tie strap anchor component 18 further consists of a strip of very high bond tape or layer of adhesive 20 (not shown), which is positioned between the bottom surface of the anchor component 18 thus ensuring that the anchor component 18 will not move or rotate on the plug once attached thereon by the user.

As shown in FIG. 1, the corresponding clip component 22 has been secured to the female plug 14. It consists of a clip 24 and means for attaching the clip 24 to the plug 14. In this embodiment, the means for attachment is a tie strap 26 and locking mechanism 28 which is integral with the clip base.

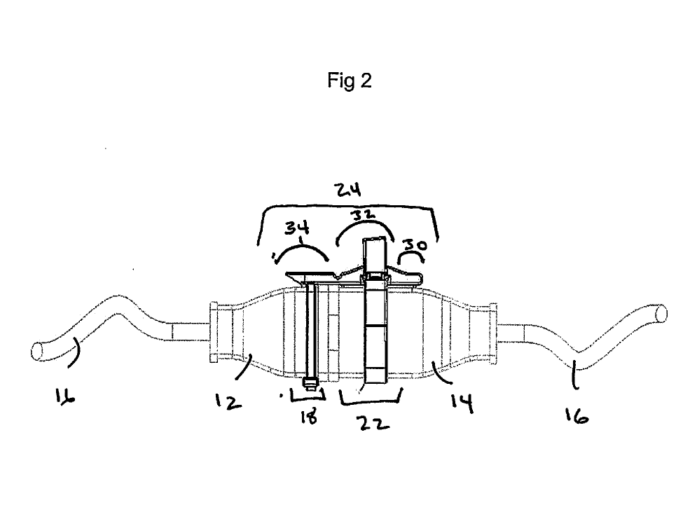

FIG. 2 shows a side view of an embodiment of the inventive device shown in FIG. 1. It shows the corresponding male 12 and female 14 plugs of the electric power cables connected together with the inventive device securing the connection. It also shows the anchor component 18 secured to the male plug and clip component 22 secured to the female plug. It further shows that the clip 24 generally consists of three contiguous portions including a heal 30, base 32 and toe 34. The base 32 is the middle portion of the clip 24 between the heal 30 and the toe 34. In the embodiment shown, the base is integral with the tie strap and tie strap locking mechanism. The heal 30 is that portion of the clip which extends toward inward from the base providing additional stability for the clip 24 when the toe 34 is pulled upwards to engage or disengage the anchor. When the toe 34 is pulled up (either by the user gipping and pulling upwards or the toe sliding over the anchor upon engagement), the heal 30 is leveraged downward against the plug providing additional stability and helping insure that the toe 34 will return to its normal position when released by the user or engaged with the anchor. The toe 34 is that portion of the clip mechanism which extends outward from the base and over the plug edge when secured to the plug. The distal end portion of the toe has a lip 36 which extends upwards from the bottom surface at an angle as shown. The angled bottom surface of the lip provides additional space between bottom of the toe and the plug for a user tin positioning a thumb or finger to lift the toe upwards during engagement of disengagement of the clip from the anchor. The angled bottom surface of the toe also assists in allowing the toe to slide more easily over the anchor. As shown, a flex point 38 (in this case a groove) may be located between the toe and the base portions of the clip to allow additional flex of the toe as it is clip is being engaged. The material used for the clip provides enough strength and elasticity for the clip to return to a normal position upon being release or engaged with the anchor. Inward from the lip and extending downward at an angle toward the base is a claw protrusion 40 which serves as a catch against the anchor when the components are engaged as shown in FIGS. 1 and 2.

One will note that alternative embodiments of the clip component might include a toe portion mounted with the base using a spring as the flex point. Similarly, the toe portion could be mounted with a hinged spring (such as with the spring used with an ordinary clothes pin) to allow the claw to remain engaged and released as desired. Further alternative embodiments could utilize alternative attachment means for attaching the clip to the plug, socket or faceplate. Such alternative means could be straps attached by hook and loop fasteners, snaps, buttons and other known attachment means including strong adhesives, adhesive tapes and the like. IN a preferred embodiment of the clip component, a strip of very strong bond adhesive tape is attached to the bottom surface of the attachment means to ensure the position of the component on the plug during use. Such additional attachment means is contemplated but not shown in the drawings.

One should also note that the materials used to form the clip and anchor components must be appropriate to provide enough strength of attachment to prevent accidental disengagement without preventing the components from being pulled apart using reasonable force in an emergency situation. The embodiment shown in FIGS. 1 and 2 are generally made of vinyl, PVC plastic, hard rubber and similar materials that are useful because they can be molded during manufacture and have enough strength and to provide the necessary binding power and elasticity to allow easy engagement and disengagement when desired. It is generally understood in the industry that engaging components (such as the clip and anchor components shown and described herein) that can withstand at least 10 pounds of pulling force without disengaging from one another will prevent the majority of plugs from disengaging from one another. It is also generally recommended (or in some cases mandated) for safety purposes that joined electric cable plugs have the ability to be disengaged with not more than 25 pounds of pulling force. The various embodiments of the adaptor components shown and described provide enough locking strength to withstand at least 10 pounds of pulling force when engaged and enough elasticity to allow disengagement with not more than 25 pounds of pulling force.

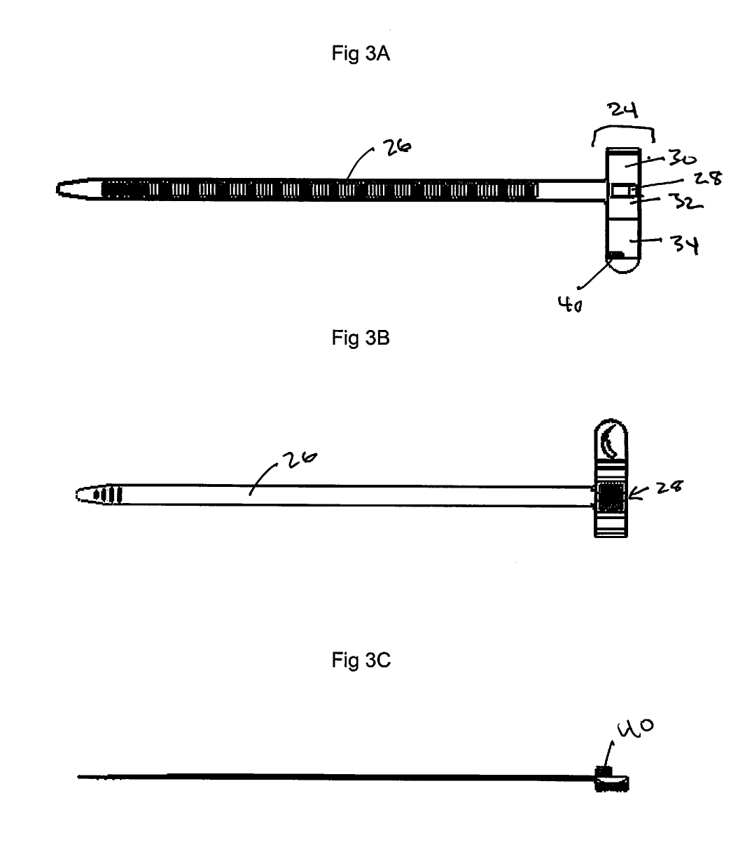

FIGS. 3A, 3B and 3C show various perspective views of an embodiment of the clip component 22 shown in FIGS. 1 and 2. This view shows the bottom surface of the integral tie strap 26 as well as the heal 30, base 32, and toe 34 portions of the clip 24. Note that the bottom surface of the tie strap has grooves for engaging with the tie strap locking mechanism 28 (or “pawl”) which is integral with the base portion of the clip 24. In a preferred embodiment, the bottom surface of the base and bottom surface of that portion of the strap coming in direct contact with the plug will have a layer of very strong bond adhesive tape mounted to it to ensure that the clip is securely mounted to the plug and will not move or rotate during use. The layer of adhesive tape has been unintentionally omitted from the drawings, but is contemplated by the invention.

One will note from FIG. 3A that the claw protrusion 40 is roughly half as wide as the width of the toe 34. In alternative embodiments, the width of the protrusion may be the full width or the toe less than the full width as long as it provides enough width to adequately engage the anchor when engaged.

FIG. 3B is a top view of the embodiment of the clipping component shown in FIGS. 1 and 2. The top portion of the tie strap 26 is smooth except for the tip end which has raised protrusions which provide a gripping surface for pulling the tie strap through the locking mechanism 28 integral with the base of the clip. The top surface of the base is raised and has grooves for assisting the user in the positioning of the base on the plug end when the clipping component is being secured to the plug. This raised portion is thus helpful but not absolutely necessary. The toe portion, as shown, has a raised claw design indicia for aesthetic purposes and to generally indicate the location of the claw-like protrusion extending downward from the bottom surface.

FIG. 3C is a side view of the embodiment of the clip component shown in FIGS. 1 and 2. In this view, the clip component is shown bottom side up such that the claw protrusion 40 is extending up and away from the bottom surface at an angle. This angle is preferred for making sure that the claw protrusion slides easily over the anchor when the components are joined and in ensuring a snug fit against the inside anchor edge.

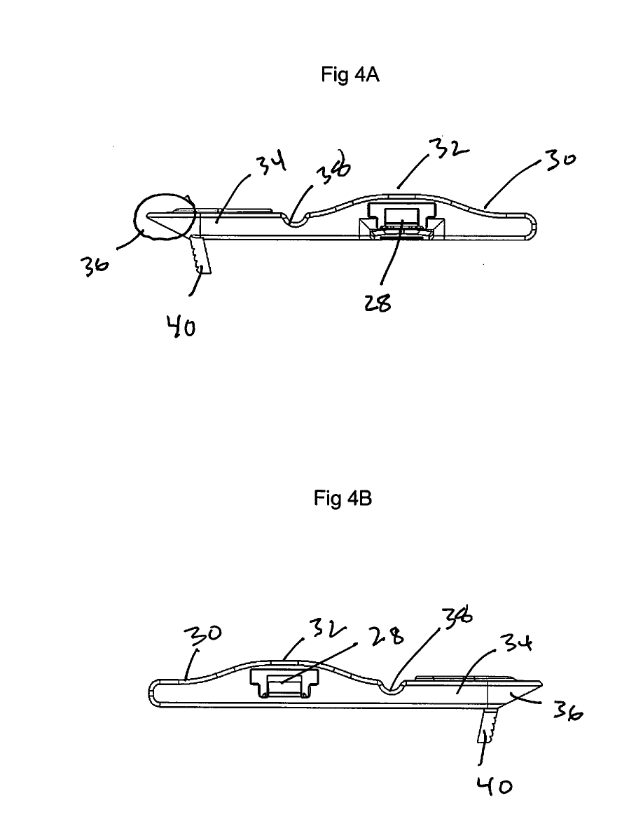

FIGS. 4A and 4B are end views of the clip component. FIG. 4A shows a base end view and FIG. 4B shows a strap end view. The various portions of the clip mechanism are marked for clarity including the base 32, heal 30 and toe 34 portions, as well as the angled lip 36, downwardly protruding claw 40 and flex point groove 38. The tie strap locking mechanism 28 is integral with the base 32 portion of the clip 24.

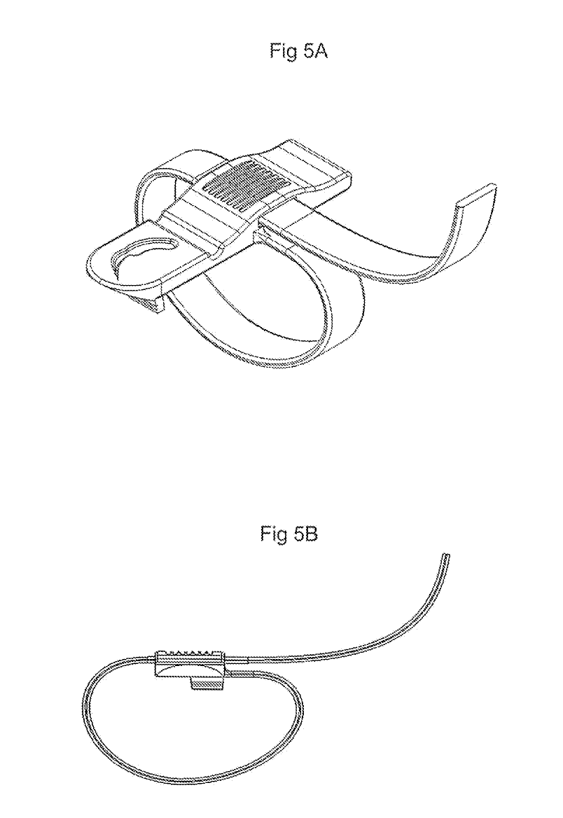

FIGS. 5A and 5B show perspective views of the embodiment of the clip component described above in looped position. The grooved bottom surface of the tie strap has been omitted.

In addition to the adaptor device, the inventor is claiming a method for using the adaptor to secure the connection of corresponding electric cable plugs or plug to socket or socket faceplate connections. The steps for using include:
1. Attaching one or more anchor components to an electrical cable plug (male or female) to be joined with a corresponding plug or wall socket;
2. Attaching a clip component to the corresponding plug type (male or female) or wall socket;
3. Aligning the clipping component with the corresponding anchor component such that the components may be securely engaged when the plugs (and/or plug and wall socket) are joined together.
4. Engaging the connection between plugs (and or plug and wall socket) by fitting the male prongs into the female socket holes and pushing together such that the claw protrusion extending from the bottom surface of the toe will slide over the anchor component and be secured in place.
5. Disengaging the clip component from the anchor component by lifting up on the toe portion of the clip such that the bottom edge of the claw protrusion is above the top surface of the anchor, and pulling the plugs apart (or plug from the socket).

As explained above, an alternative step for disengaging the clip component from the anchor component is to pull the plugs away from one another using a pulling force of 25 or more pounds thus causing the protruding claw to slide back over the anchor (i.e. disengage the catch) and allow the plugs to be pulled apart in an emergency situation.

As one familiar in the art will appreciate, an alternative embodiment of the device may be utilized to secure the connection of a electrical plug to a corresponding socket or socket faceplate. Such alternative embodiment would have the clip component connected with a socket of socket faceplate (either as a built in component or by attachment with adhesives or other connecting means known in the art) and the anchor component attached to the male plug end. The clip component would necessarily stick out and away from the front surface of the socket or faceplate such the toe and protruding claw could extend over and secure with the anchor when the plug is inserted into the socket. No formal drawings have been submitted showing the details of such an embodiment, but it can be appreciated that the clip would be essentially the same as that shown in the drawing described above except that the base would be attached to the side of the socket with the toe and claw protrusion extending beyond the face of the socket. For use with a socket faceplate, the clip must be integrated with the edge of the socket hole such that the toe and protruding claw will extend outward from the face and is positioned to engage with the anchor attached to the male socket.

Although the description of the above contains many specificities, these should not be construed as limiting the scope of the embodiments but as merely providing illustrations of some of the several embodiments. For example, anchor and clip components may be of a different shape, width or thickness, the bottom surface of the clip and anchor components may have a layer of adhesive tape to more strongly secure the components to the plugs and/or socket or socket faceplate, the means for attaching the anchor and clip components may include alternative means such as hook and loop straps, adhesives or straps having alternative fastening means generally known and understood in the art. Additionally, as discussed above, various materials can be used to fashion the components to meet the specific requirements of strength and elasticity. The size and length of the claw protrusion could vary depending on the strength and elasticity of the materials used. And, as discussed, the components may be built into the plug and/or socket or socket faceplate negating the need for a securing means to secure the anchor or clip components to the plugs, socket or socket faceplate. Thus, the scope of the embodiments should be determined by the appended claims and their legal equivalents, and not solely by the examples shown and described.

1. A device for securing a connection between connected male and female type electrical plugs comprising:
an anchor component having one or more anchors and means for attaching the one or more anchors to an electrical plug;
a clip component having one or more clips and means for attaching the one or more clips to a corresponding electrical plug;
said one or more clips further comprised of heal, base and toe portions, each toe portion having a lip and one or more protruding claws;
wherein the clip component engages with the anchor component when aligned on corresponding male and female type plugs and the plugs are connected together.

2. The device of claim 1 wherein the anchor component is configured for attachment to the male type plug and the clip component is configured for attachment to a corresponding female type plug.

3. The device of claim 1 wherein the anchor component comprises a cable tie.

4. The device of claim 1 wherein the toe lip angles upward and outward from the bottom surface of the toe.

5. The device in claim 1 wherein the protruding claw extends downward at an angle toward the base.

6. The device in claim 1 wherein a flex point groove is positioned between the toe and base portions of the clip.

7. The device of claim 1 further comprising a layer of strong bond adhesive tape attached to the bottom surface of the clip base.

8. The device of claim 1 further comprising a layer of strong bond adhesive tape attached to the bottom surface of the clip heal.

9. The device of claim 1 wherein the protruding claw will catch on the anchor to prevent disengagement of the connected plugs when the plugs are pulled away from one another with less than 10 pounds of pulling force.

10. The device of claim 1 wherein the clip component will disengage from the anchor component when the plugs are pulled away from one another with 25 or more pounds of pulling force.

11. The device of claim 1 wherein the anchor component is configured for attachment to a male plug and the clip component is configured for attachment to a socket or socket faceplate.

12. The device of claim 1 wherein the clip component is made of vinyl material.

13. The device of claim 1 wherein the clip component is easily disengaged from the anchor component by pulling the toe upwards so that the bottom edge of the claw protrusion is higher than the top of the anchor and the plugs are pulled apart from one another.

14. The device of claim 1 wherein the clip is made of material having enough strength and elasticity to allow the toe to return to its normal position following disengagement of the clip from the anchor.

15. The device of claim 1 wherein the anchor component is built into the electrical plug.

16. The device of claim 1 wherein the clip component is built into the electrical plug.

17. A method of using the device for securing the electrical connection between connected electrical cable plugs comprising the following steps:
a) attaching an anchor component to an electrical cable plug to be joined with a corresponding plug or wall socket;
b) attaching a clip component to a corresponding electric cable plug or wall socket;
c) aligning the clip component with the corresponding anchor component such that the components may be securely engaged when the plugs (and/or plug and wall socket) are joined together;
d) engaging the connection between plugs (and or plug and wall socket) by fitting the male prongs into the female socket holes and pushing together such that the claw protrusion extending from the bottom surface of the clip toe slides over the anchor component;
e) disengaging the clip component from the anchor component by lifting up on the toe portion of the clip such that the bottom edge of the claw protrusion is above the top surface of the anchor and pulling the plugs apart (or plug from the socket);

18. The method of claim 17 wherein the step of disengaging the clip component from the anchor component consists of pulling the plugs apart with 25 or more pounds of pulling force to cause the claw protrusion to slip back over the anchor thus allowing disengagement of the plugs in an emergency situation.
